(19) United States
(12) Patent Application Publication
(10) Pub. No.: US 2011/0034839 A1
(43) Pub. Date: Feb. 10, 2011

(54) Massage recliner

(76) Inventors: Mei-Hua YANG, Cupertino, CA (US); Xiao-Mei Zhou, Cupertino, CA (US)

Correspondence Address: DAHYEE LAW GROUP, 5776 Stoneridge Mall RD, SUITE288, Pleasanton, CA, 94588, US

(21) Appl. No.: 12/462,854

(22) Filed: Aug. 10, 2009

(51) Int. Cl. A61H 15/00

(52) U.S. Cl. 601/128

(57) ABSTRACT

A massage recliner includes a seat member, a back member, an inverted “T” shape front leg, two arms attached to the back member, an inverted “T” shape rear leg, a gas spring which is pivotally attached to the inverted “T” shape rear leg and to the back member, a footrest attached to the seat member, and a head support attached to the back member. The back member includes two or more pairs of massage rollers symmetrically coupled to its backbone. The seat member includes two or more pairs of massage rollers symmetrically coupled to its central frame. The inverted “T” shape front leg is vertically coupled to the central frame of the seat member. The footrest includes a pair of massage rollers symmetrically coupled to a metal piece attached to the seat member's central frame. The back member's reclining angle is determined by the gas spring, which is controlled by the user through a control handle attached to one of the arms.

### FIELD OF THE INVENTION

The present invention generally relates to exercise furniture, and more particularly to a massage recliner which enables a user to enjoy massage while exercising.

### BACKGROUND OF THE INVENTION

Massage is the practice of soft tissue manipulation with physical, functional, and in some circumstances psychological purposes and goals. The word comes from the French massage meaning “friction of kneading”, or from Arabic massa meaning “to touch, feel or handle” or from Latin massa meaning “mass, dough” or from Chinese an-mo meaning “pressing and rubbing”. An older etymology may even have been the Hebrew me-sakj meaning “to anoint with oil”. Massage involves acting on and manipulating the body with pressure—structured, unstructured, stationary, or moving—tension, motion, or vibration, done manually or with mechanical aids. Target tissues may include muscles, tendons, ligaments, skin, joints, or other connective tissue, as well as lymphatic vessels, or organs of the gastrointestinal system. Massage can be applied with the hands, fingers, elbows, forearm, and feet. In professional settings massage involves the client being treated while lying on a massage table, sitting in a massage chair, or lying on a mat on the floor.

Many kinds of massage chairs or robot massage chairs have been developed. Ergonomically designed chairs for positioning a person who will be receiving a massage is similar in function to a massage table. Massage chairs may be either stationary or portable models. Different chairs have different features, and many are adjustable to clients' preferences and sizes. Massage therapists are able to offer on-site massage to many places of employment because of the portability of the massage chair. Massage chairs are easier for the therapist to maneuver than massage tables, and clients do not need to disrobe to receive a chair massage.

A robotic massage chair is a chair or a sofa set that contains internal electronic motors and an assembly of gears designed to massage the person sifting therein. Most robotic massage chairs have some form of controller to vary the type, location, or intensity of massage. There are many different types and brands, including office-style chairs that operate from internal batteries. A less expensive option is a separate massaging pad that may be used with an existing chair. Robotic massaging chairs vary tremendously in price, style and intensity, from cheap “vibrate only” chairs to full intensity Shiatsu models for people who require as close to a real invigorating massage as possible.

Robotic massaging chairs usually resemble recliners. A recliner is an armchair that reclines when the user lowers the chair's back and raises its front. It has a backrest that can be tilted back, causing a footrest to extend from the front. It provides the user more comfort than most of the conventional chairs and becomes more and more popular all over the world in luxury accommodations. A conventional recliner usually includes a main frame and a supporting seat mounted on the main frame for a user to seat thereon. The main frame includes two rocking leg frames each having a curved bottom surface for guiding a rocking movement of the recliner. When the user is seating on the recliner, he is adapted to exert a slight rocking force towards the main frame for generating a rocking movement of the recliner. The rocking movement usually imparts the user with a unique comfort when sitting on the recliner. The conventional recliner does not have massage functions.

What is desired is an apparatus that enables the user to exercise, relax and enjoy massage concurrently without using electrical power.

### SUMMARY OF THE INVENTION

The present invention discloses and teaches a massage recliner that enables the user to exercise, relax and enjoy massage concurrently without using electrical power. In one preferred embodiment, the massage recliner includes a seat member, a back member, a front leg with two supporting points, two arms attached to the back member, a rear leg with two supporting points, a gas spring which is pivotally attached to the rear leg and to the back member, a footrest attached to the seat member, and a head support attached to the back member. The rear leg is mounted to the seat member. The back member is pivotally coupled to the seat member. The back member includes two or more pairs of massage rollers symmetrically coupled to its backbone and its contour frame. The seat member includes two or more pairs of massage rollers symmetrically coupled to its central frame and its contour frame. The footrest includes a pair of cylindrical pads symmetrically coupled to a metal piece attached to the seat member's central frame. The back member's reclining angle is determined by the gas spring, which is controlled by the user through a control handle attached to one of the arms.

In another equally preferred embodiment, the massage recliner includes a seat member, a back member which is pivotally coupled to the seat member, an inverted “T” shape front leg, two arms attached to the back member, an inverted “T” shape rear leg which is attached to the seat member, a gas spring which is pivotally attached to the inverted “T” shape rear leg and to the back member, a footrest attached to the seat member, and a head support attached to the back member. The back member includes two or more pairs of massage rollers symmetrically coupled to its backbone. The seat member includes two or more pairs of massage rollers symmetrically coupled to its central frame. The inverted “T” shape front leg is vertically coupled to the central frame of the seat member. The footrest includes a pair of massage rollers symmetrically coupled to a metal piece attached to the seat member's central frame. The back member's reclining angle is determined by the gas spring, which is controlled by the user through a control handle attached to one of the two arms.

### BRIEF DESCRIPTION OF THE FIGURES

FIG. 1 is a schematic perspective diagram illustrating a massage chair and a detached footrest according to the principle of the present invention;

FIG. 2A is a schematic diagram illustrating a front view of a massage roller according to the invention;

FIG. 2B is a schematic diagram illustrating a side view of the massage roller in FIG. 2A;

FIG. 2C is a schematic diagram illustrating a front partially sectional view of the massage roller in FIG. 2A;

FIG. 3A is a schematic diagram illustrating a side view of an exemplary frame structure of a massage recliner according to one preferred embodiment of the invention;

FIG. 3B is a schematic diagram illustrating a reclined position of the massage recliner of FIG. 3A;

FIG. 4A is a front view of the head support used in the massage recliner of FIG. 3A;

FIG. 4B is a side view of the head support of FIG. 4A;

FIG. 4C is a top view of the head support of FIG. 4A;

FIG. 4D is a front view of the head support with a centralized sliding trail;

FIG. 5A is a schematic diagram illustrating the front view of the back of the massage recliner of FIG. 3A;

FIG. 5B is a schematic diagram illustrating a side view of the back of the massage recliner of FIG. 3A;

FIG. 6 is a schematic diagram illustrating a top view of the seat of the massage recliner of FIG. 3A;

FIG. 7A is a schematic diagram illustrating a top view of the built-in footrest of the massage recliner of FIG. 3A;

FIG. 7B is a schematic diagram illustrating a side view of the built-in footrest of the massage recliner of FIG. 3A;

FIG. 8A is a schematic diagram illustrating a side view of an exemplary frame structure of a massage recliner according to another preferred embodiment of the invention;

FIG. 8B is a schematic diagram illustrating a top view of the massage recliner of FIG. 8A;

FIG. 8C is a schematic diagram illustrating a side view of the massage recliner of FIG. 8A in a flat position;

FIG. 8D is a schematic diagram illustrating a side view of the massage recliner of FIG. 8A in a flat position while the footrest is down-folded;

FIG. 9A is a schematic simplified diagram illustrating a front view of the back of the massage recliner of FIG. 8A;

FIG. 9B is a schematic simplified diagram illustrating a side view of the back of the massage recliner of FIG. 8A;

FIG. 10 is a schematic diagram illustrating a front view of the inverted “T” shape front leg of the massage recliner of FIG. 8A; and

FIG. 11 is a schematic diagram illustrating a front view of the inverted “T” shape rear leg of the massage recliner of FIG. 8A.

### DETAILED DESCRIPTION OF THE INVENTION

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation or restriction of the scope of the invention is thereby intended. Any alterations and further implementations of the principles of the invention as described herein are contemplated as would normally occur to one skilled in the art to which the invention relates.

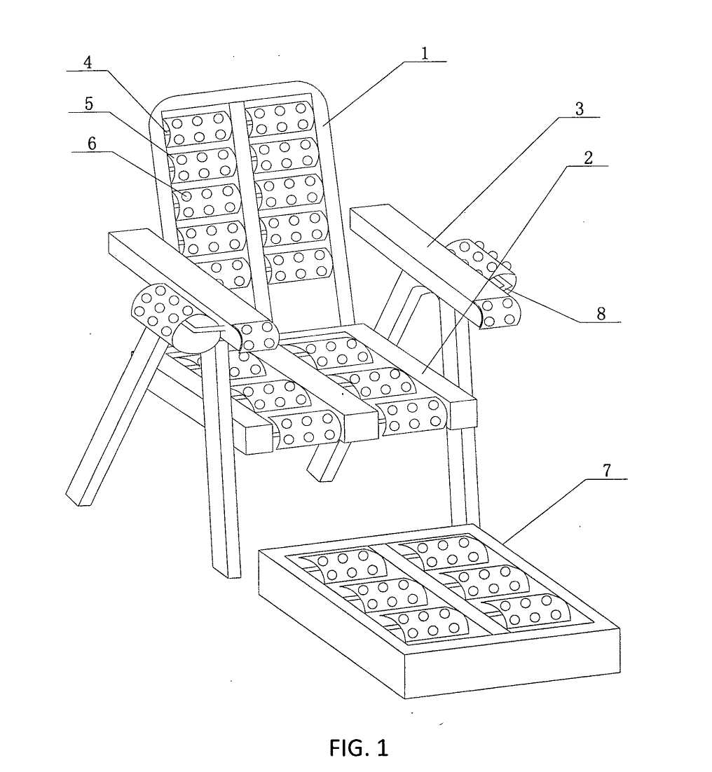

FIG. 1 is a schematic perspective diagram illustrating a massage chair and a detached footrest. The massage chair has a wood frame with a number of massage rollers fixed to the back frame 1, the seat frame 2, and the arms 3. The detached foot rest includes a wood frame 7 with six massage rollers. Each massage roller includes a bearing 4, a tube-shaped body 5, and a number of nipple-shaped or semi-spherical objects 6 which are evenly spaced and embedded in the body 5. The body 5 and the nipple-shaped or semi-spherical objects 6 are made of the same materials. When the user moves on the chair, the massage rollers turn back and forth in responding to the vertical force from the human body. The nipple-shaped or semi-spherical objects 6 apply forces against the human body touching the objects, simulating the human fingers doing the massage.

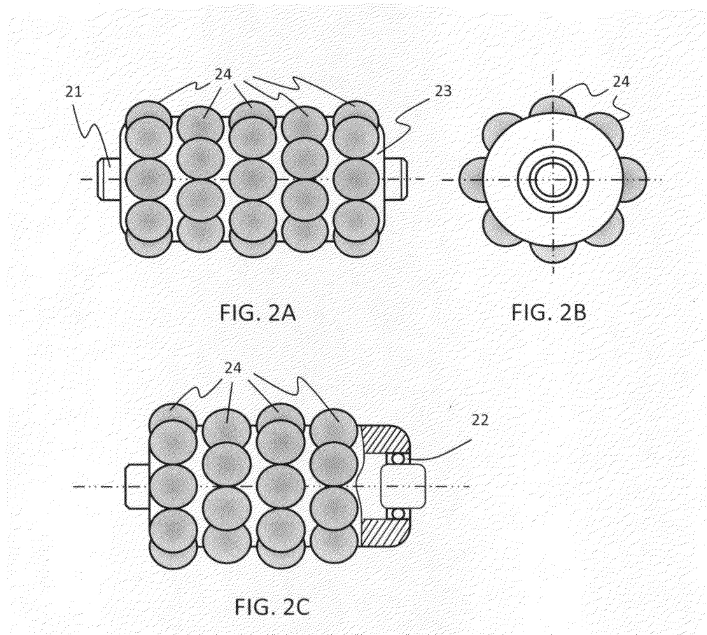

FIGS. 2A-2C illustrates, respectively, a front view, a side view, a front partially sectional view of the massage roller used in the massage chair of FIG. 2A and the other embodiments described below. The massage roller includes a bearing 21, preferably a ball bearing 22, a cylindrical body 23, and a number of nipple-shaped or semi-spherical bumps 24 which are evenly spaced and embedded in the cylindrical body 23. The cylindrical body 23 and the bumps 24 are made of the same materials such as rubber. When the massage roller touches human body, the human body's tangent movement causes the massage roller rotate. When the massage roller rotates, the bumps thereon apply forces to the human body, imitating the massaging forces of human fingers.

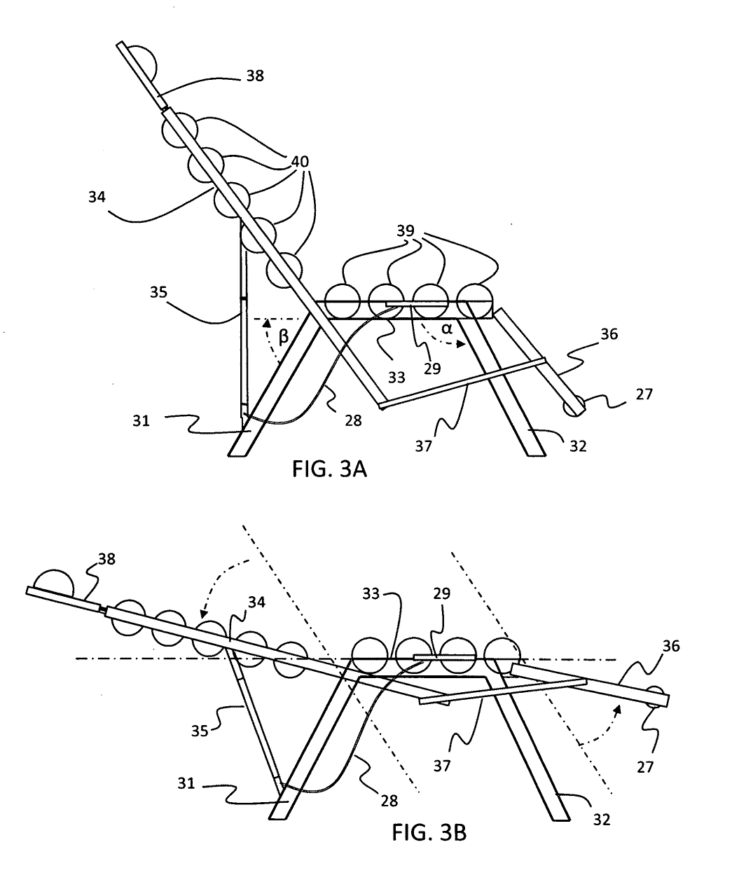

In the first preferred embodiment as illustrated in FIG. 3A through FIG. 7B, the massage recliner includes a seat member, a back member, a front leg with two supporting points, two arms attached to the back member, a rear leg with two supporting points, a gas spring which is pivotally attached to the rear leg and to the back member, a footrest attached to the seat member, and a head support attached to the back member. The back member includes two or more pairs of massage rollers symmetrically coupled to its backbone and its contour frame. The seat member includes two or more pairs of massage rollers symmetrically coupled to its central frame and its contour frame. The footrest includes a pair of cylindrical pads symmetrically coupled to a central metal piece attached to the seat member's central frame. The back member's reclining angle is determined by the gas spring, which is controlled by the user through a control handle attached to one of the arms.

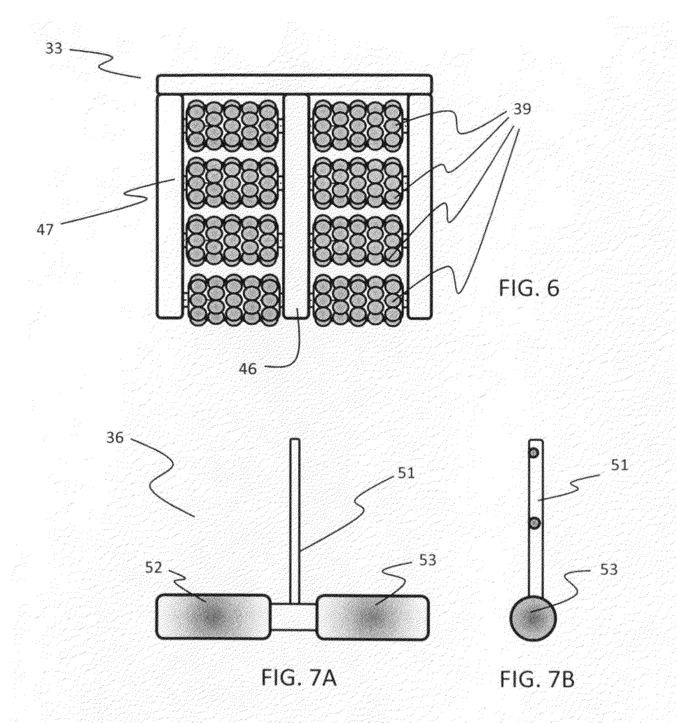

FIG. 3A schematically illustrates a side view of an exemplary frame structure of a massage recliner in a default position according to the first preferred embodiment of the invention. The frame structure includes a seat member 33, a pair of rear legs 31 with two supporting points as in a conventional chair, a pair of front legs 32 with two supporting points as in a conventional chair, a back member 34, a gas spring 35 with its two ends pivotally connected to the back member 34 and the rear legs 32, a build-in footrest 36, and a head support 38. Both the front legs 32 and the rear legs 31 are coupled to said seat member 33. The control handle 29 is connected to the gas spring 35 through a conduit 28. The footrest 36 is pivotally connected to the front end of the seat member 33 and is dynamically connected to a central frame member, called backbone, of the back member 34 through a correlating connector 37. The backbone refers to the central metal piece 44 in the frame of the back member 34 as illustrated in FIG. 5A. When the massage recliner is in the default position, the footrest 36 is fully reclined as shown in FIG. 3A, and the back member 34 is at an angle ranging from 90-120 degrees to the seat member 33. FIG. 3B is a schematic diagram illustrating a reclined position of the massage recliner of FIG. 3A. When the back member 34 is reclined downward, the footrest 36 automatically moves upward. When the back member 34 is in a same plane with the seat member 33, the footrest 36 is also in a same or a substantially same plane with the seat member 33 due to the correlating connector 37. The seat member 33 includes an “E” shape frame and a number of massage rollers which are preferably arranged in two columns symmetrical to a central frame member 46 as illustrated in FIG. 6. Similarly, the back member 34 includes a number of massage rollers which are preferably arranged in two columns in a frame. The frame of the back member 34 includes a backbone 44 and a contour frame 45 as illustrated in FIG. 5A.

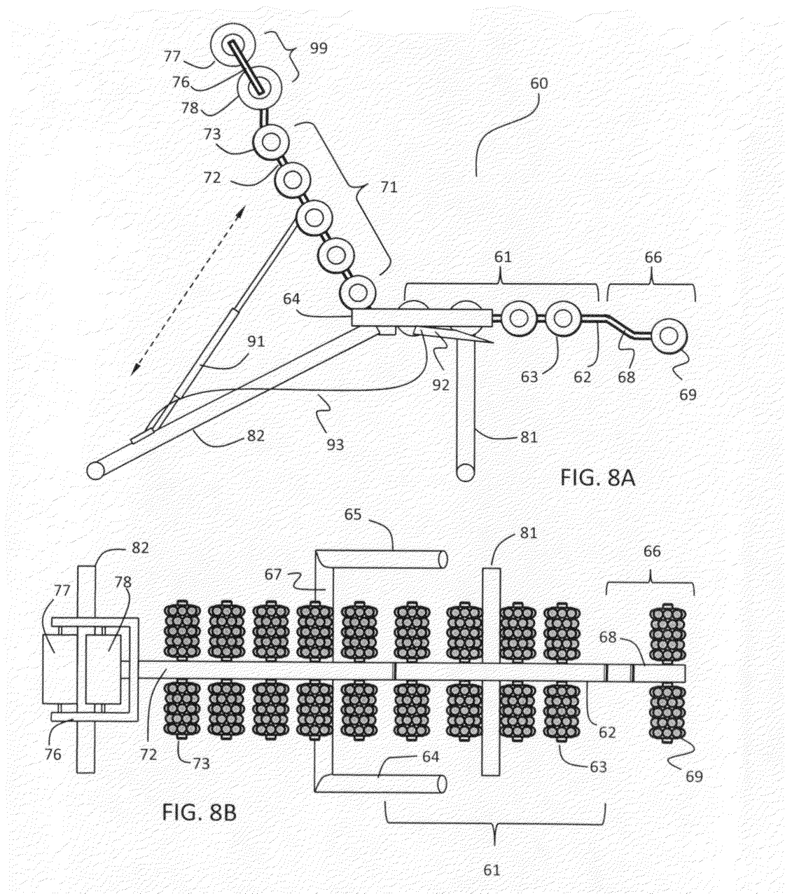

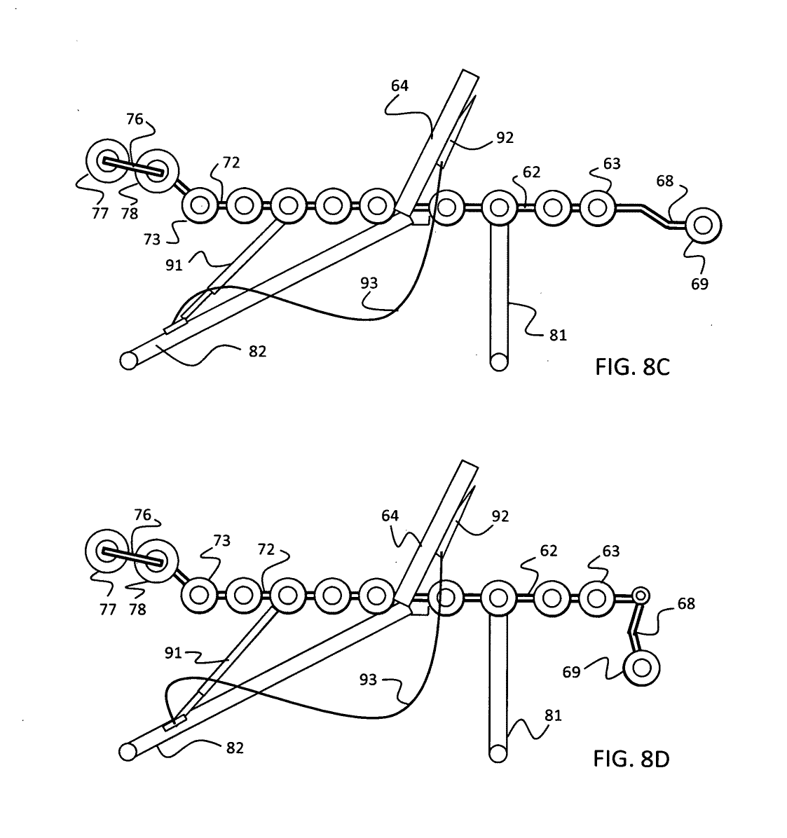

Referring to FIG. 3A, the pair of front legs 32 can be in “H” shape, inverted “V” shape or inverted “U” shape or any other shape with two supporting points. The inner angle a between the front legs 32 and the plane of the seat member 33 preferably ranges between 90 to 135 degrees. Similarly, the pair of back legs 31 can be in “H” shape, inverted “V” shape or inverted “U” shape or any other shape with two supporting points. The outer angle β between the rear legs 31 and the plane of the seat member 33 preferably ranges between 30 to 60 degrees. Note that the limitations on the inner angle α and the outer angle β described above and illustrated in FIG. 3A can be applied to the embodiment described below and illustrated in FIG. 8A through FIG. 8D.

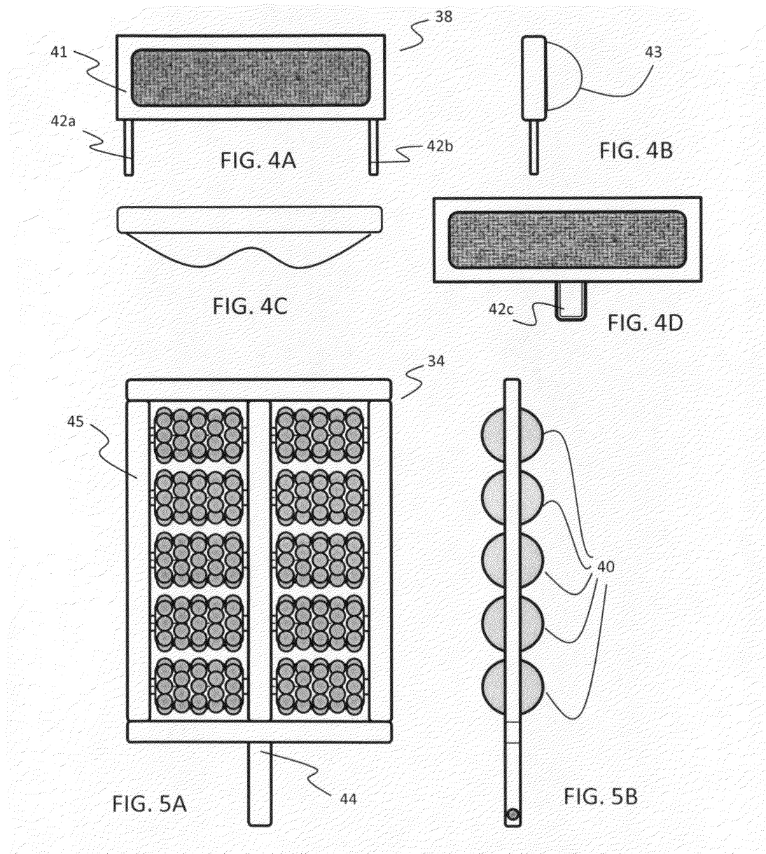

FIGS. 4A through 4C respectively illustrate a front view, a side view and a top view of an exemplary head support 38 used in the massage recliner of FIG. 3A. The head support 38 includes a pad base 41 which is a hard board, a soft pad 43 attached to the pad base 41, and a pair of sliding trails 42a-42b. Alternatively, the sliding trails can be centralized as a single trail 42c as illustrated in FIG. 4D. Now referring back to FIG. 3A, when the user's head moves tangentially up and down against the pad 43, the entire head support 38 moves up and down accordingly. Alternatively, the head support can be one or two rollers with massage quality surface as illustrated in FIG. 8A through FIG. 8D. When the user's head and neck move up and down, the roller or rollers rotate, the rollers apply massage forces to the head and neck, imitating the massaging forces of human palms.

FIG. 5A and FIG. 5B illustrate respectively a front view and a side view of the back member 34 of the massage recliner of FIG. 3A. The back member 34 includes five pairs of the massage rollers 40 mounted to the contour frame 45 and to the backbone 44 which is a central metal piece of the frame. The two columns of massage rollers 40 are symmetrical to the backbone 44. Referring back to FIG. 3A, when the user's back moves tangentially against the back member 34, the massage rollers 40 rotate accordingly, and the nipple-shaped or semi-spherical bumps thereon apply forces to the muscles of the user's back, imitating the massaging forces of human fingers.

FIG. 6 is a schematic diagram illustrating a top view of the seat member 33 of the massage recliner of FIG. 3A. The seat member 33 includes four pairs of the massage rollers 39 which are coupled to an “E” shaped frame. The “E” shaped frame includes a central metal piece 46 and a contour frame 47. The two columns of massage rollers 39 are symmetrical to the central piece 46. Referring back to FIG. 3A, when the user's buttock moves back and forth on the seat member 33, the massage rollers 39 rotate accordingly, and the nipple-shaped or semi-spherical bumps thereon apply forces to the user's buttock muscles, imitating the massaging forces of human fingers.

FIG. 7A and FIG. 7B are schematic diagrams respectively illustrating a top view and a side view of the built-in footrest 36 of the massage recliner of FIG. 3A. The footrest 36 includes a central frame member 51 and a pair of foot supports 52-53. The foot supports 52-53 can be cylindrical pads or conventional pedals as used in bicycle. The cylindrical pads can be either non-rotatable or rotatable. Referring back to FIG. 3A, when the user pushes with his feet against the pads 52-53, his back will be moving upward, and his buttock and legs will be moving backward. When his legs relax, his back will be moving downward due to gravity, and his buttock and legs will be moving forward. During the exercising movements, the massage rollers 39-40 on the seat member 33 and the back member 34 rotate accordingly, and the nipple-shaped or semi-spherical bumps thereon apply forces to the muscles of the user's back, buttock and legs, imitating the massaging forces of human fingers. Note that the footrest as illustrated in FIG. 7A and FIG. 7B can be applied to the embodiment described below and illustrated in FIG. 8A through FIG. 8D.

In another equally preferred embodiment, as illustrated in FIG. 8A through FIG. 11, the massage recliner includes a seat member, a back member, an inverted “T” shape front leg, two arms attached to the back member, an inverted “T” shape rear leg, a gas spring which is pivotally attached to the inverted “T” shape rear leg and to the back member, a footrest attached to the seat member, and a head support attached to the back member. The back member includes two or more pairs of massage rollers symmetrically coupled to its backbone. The seat member includes two or more pairs of massage rollers symmetrically coupled to its central frame. The inverted “T” shape front leg is vertically coupled to the central frame of the seat member. The footrest includes a pair of massage rollers symmetrically coupled to a metal piece attached to the seat member's central frame. The back member's reclining angle is determined by the gas spring, which is controlled by the user through a control handle attached to one of the two arms.

FIG. 8A schematically illustrates a side view of an exemplary frame structure of a massage recliner 60 according to the second preferred embodiment of the invention. FIG. 8B schematically illustrates a top view of the massage recliner 60 of FIG. 8A. The massage recliner 60 includes a seat member 61, a back member 71, an inverted “T” shape front leg 81, two arms 64-65 attached to the back member 71, an inverted “T” shape rear leg 82, a gas spring 91 which is pivotally attached to the inverted “T” shape rear leg 82 and to the back member 71, a footrest 66, and a head support 76.

The seat member 61 includes a central metal piece 62 with two or more pairs of massage rollers such as 63 which are mechanically vertically coupled to the central metal piece 62. The massage rollers are preferably arranged in two columns symmetrical to the central metal piece 62. When the user's buttock moves back and forth on the seat member 61, the massage rollers 63 rotate accordingly, and the nipple-shaped or semi-spherical bumps thereon apply forces to the user's buttock muscles, imitating the massaging forces of human fingers.

Referring back to FIG. 8A, when the user holds the control handle 92 to the end, the gas spring 91 pulls the back member 71 to the flat position as illustrated in FIG. 8C which is a schematic diagram illustrating a side view of the massage recliner 60 of FIG. 8A, the flat position means that the back member 71 and the seat member 61 are in a same plane.

Referring to FIG. 8A and FIG. 8B, the footrest 66 includes a pair of massage rollers 69 vertically coupled to a single metal piece 68. In a typical configuration, the metal piece 68 and the metal piece 62 are two segments of a same metal piece. In that case, the footrest 66 cannot be folded. In another configuration, the metal piece 68 and the metal piece 62 are separate and pivotally joined and locked. When they are unlocked, the footrest 66 can be folded as illustrated in FIG. 8D. Yet in another configuration, the metal piece 68 and the metal piece 62 can be dynamically coupled by insertion, which means part of the metal piece 68 is inserted into the metal piece 62 and the insertion depth can be manually adjusted and locked.

Referring to FIG. 8A through FIG. 8D, the head support 99 includes two paralleling soft cylindrical pads 77-78 coupled to a metal frame 76. The cylindrical pads have massage quality, which means not too hard and not to soft for human head and neck. In a typical configuration, the metal frame 76 is welded to the backbone metal piece 72. In that case, the head support 99 cannot be folded. In another configuration, the metal frame 76 and the backbone metal piece 72 are separate and pivotally joined and locked. When they are unlocked, the head support 99 can be folded or adjusted.

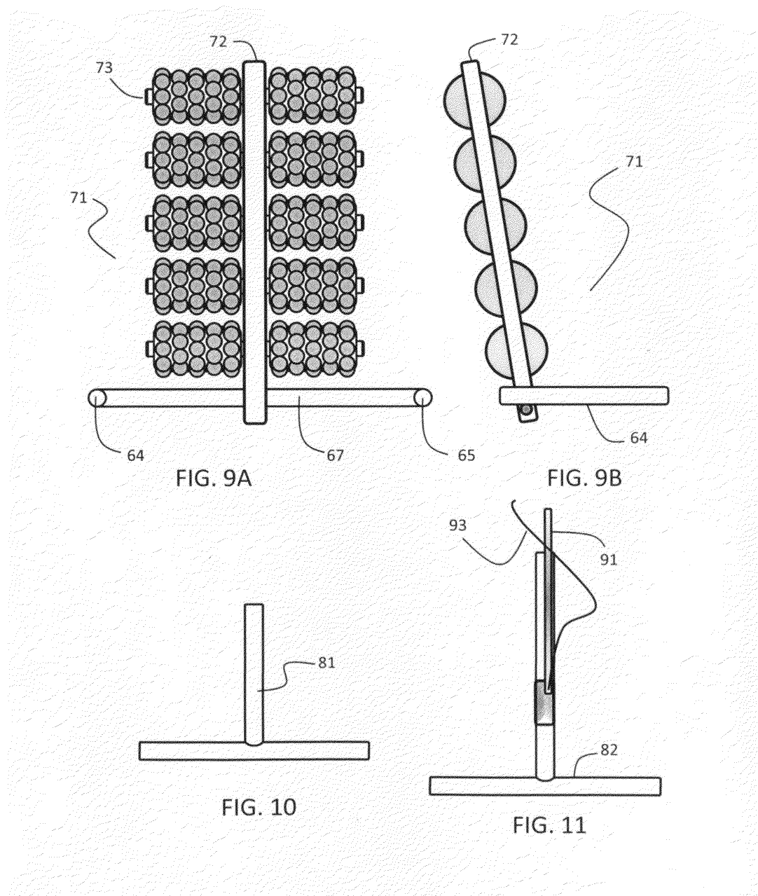

FIG. 9A and FIG. 9B are schematic diagrams illustrating a front view and a side view of the back member 71 in FIGS. 6A through 6D. The back member 71 includes a backbone metal piece 72 with two or more pairs of massage rollers 73 which are mechanically coupled to the backbone metal piece 72. The massage rollers such as 73 are preferably arranged in two columns symmetrical to the backbone metal piece 72. In a typical configuration, the two arms 64-65 are attached to the backbone metal piece 72 through the connection member 67. In other words, the arms 64-65, the connection member 67 and the backbone metal piece 72 can be a same piece of metal. As illustrated in FIG. 6A, FIG. 6C and FIG. 7D, the control handle 92 for the gas spring 91 is attached to the right arm 64 or the left arm 65.

FIG. 10 is a schematic diagram illustrating a front view of the inverted “T” shape front leg 81 of the massage recliner 60 of FIG. 8A. In a typical configuration, the leg 81 is made of metal tubes. Note that the front leg 81 can be either welded to the central metal piece 62 of the seat 61, or can be pivotally connected and locked to the central metal piece 62.

FIG. 11 is a schematic diagram illustrating the front view of the inverted “T” shape rear leg of the massage recliner 60 of FIG. 8A. Referring back to FIG. 8A and FIG. 9A, the gas spring 91 is pivotally coupled to the backbone metal piece 72 of the back member 71, and to the rear leg 82. The gas spring 91 is controlled by the user through the control handle 92 and the conduit 93. In a typical configuration, the leg 82 is made of metal tubes.

Referring to FIG. 8A through FIG. 8D, in an alternative configuration, the front leg 81 can be in “H” shape, inverted “V” shape or inverted “U” shape or any other shape with two supporting points. The inner angle between the front leg 81 and the plane of the seat member 61 preferably ranges between 90 to 135 degrees. Similarly, the back legs 82 can be in “H” shape, inverted “V” shape or inverted “U” shape or any other shape with two supporting points. The outer angle between the rear legs 82 and the plane of the seat member 81 preferably ranges between 30 to 60 degrees.

Referring to FIG. 8A through FIG. 8D, in an alternative configuration, in an alternative configuration, the central frame member 68 of the footrest 66, the central frame member 62 of seat member 61, the front leg 81 and rear leg 82 can in integrated in one metal piece. In another alternative configuration, they are separate metal pieces which can be assembled using conventional means.

In each of the embodiments described above, the footrest includes a central frame metal piece as member 51 in FIG. 7A and member 68 in FIG. 8A through FIG. 8D and a pair of rotatable foot supports symmetrically coupled to the central frame metal piece. The pair of foot supports can be any of: a pair of flat pedals as those used in the bicycle, a pair of cylindrical pads as the members 52-53 illustrated in FIG. 7A, and a pair of the massage rollers as illustrated in FIG. 2A through FIG. 2C. In a typical configuration, the central frame metal piece is pivotally connected to the seat member's central frame as illustrated FIG. 8C and FIG. 8D, and thus the footrest's position relative to the seat member can be adjusted manually. In another configuration, the central frame metal piece is connected to the seat member's central frame by sliding insertion, i.e. the former can be inserted or fitted in the later. For balance purpose, both the seat member's central frame and the central frame metal piece have a square shaped cross section. By the sliding insertion coupling, the user can extend or adjust the footrest's position relative to the seat member.

Furthermore, in each of the embodiments described above, the head support can be either non-rotatable as illustrated in FIG. 4A through FIG. D, or rotatable as illustrated in FIG. 8A through FIG. 8D. In a typical non-rotatable configuration, the head support includes a hard board, a soft pad mounted to the hard board, and one or more sliding trails which are mechanically coupled to the massage recliner's back member's frame. Due to the sliding coupling, the head support's position relative to the back member can be manually adjusted. In a typical rotatable configuration as illustrated in FIG. 8A and FIG. 8B, the head support 99 includes one or more rotatable cylindrical pads 77-78 coupled in a “U” shaped frame 76. The “U” shaped frame 76 is mounted to the upper end of the back member's central frame member 72. Alternatively, the “U” shaped frame 76 is connected to the back member's central frame member 72 by sliding insertion, and thus the head support's position relative to the back member can be adjusted manually.

While one or more embodiments of the present invention have been illustrated above, the skilled artisan will appreciate that modifications and adoptions to those embodiments may be made without departing from the scope and spirit of the present invention.

1. A massage recliner that enables a user to exercise, relax and enjoy massage concurrently without using electrical power, comprising: a seat member, a back member, a front leg with two supporting points, two arms attached to said back member, a rear leg with two supporting points, a gas spring with its two ends pivotally coupled to said rear leg and to said back member respectively, a footrest mechanically coupled to said seat member's front end, and a head support mechanically coupled to said back member's upper end, wherein said back member comprises first two or more pairs of massage rollers arranged in two columns symmetrical to said back member's central frame member, each of said first two or more pairs of massage rollers having its two ends mounted to said back member's central frame member and said back member's contour frame respectively, wherein said seat member comprises second two or more pairs of massage rollers arranged in two columns symmetrical to said seat member's central frame member, each of said second two or more pairs of massage rollers having its two ends mounted to said seat member's central frame member and said seat member's contour frame respectively, wherein each of said massage rollers comprises at least one ball bearing, a cylindrical body and a number of evenly spaced bumps embedded in said cylindrical body, and wherein said back member's reclining angle is determined by said gas spring which is controlled by the user through a control handle attached to one of said arms.

2. The massage recliner of claim 1, wherein said footrest comprises a third central frame member and a pair of rotatable foot supports symmetrically coupled to said third central frame member, said pair of foot supports being any of:
a pair of flat pedals;
a pair of cylindrical pads; and
a pair of said massage rollers.

3. The massage recliner of claim 2, wherein said third central frame member is pivotally coupled to a front end of said seat member's central frame, and wherein said footrest's position relative to said seat member is adjustable.

4. The massage recliner of claim 2, wherein said third central frame member is coupled to said seat member's central frame by sliding insertion, and wherein said footrest's position relative to said seat member is adjustable.

5. The massage recliner of claim 1, wherein said head support comprises a hard board and a soft pad mounted to said hard board, said hard board being mounted to one or more sliding trails mechanically coupled to said back member's frame, and wherein said head support's position relative to said back member is adjustable.

6. The massage recliner of claim 1, wherein said head support comprises one or more rotatable cylindrical pads coupled in a “U” shaped frame, said “U” shaped frame being coupled to an upper end of said back member's central frame member.

7. A massage recliner that enables a user to exercise, relax and enjoy massage concurrently without using electrical power, comprising: a seat member, a back member, an inverted “T” shape front leg coupled to said seat member, two arms attached to said back member, an inverted “T” shape rear leg coupled to said seat member, a gas spring with its two ends pivotally coupled to said inverted “T” shape rear leg and to said back member respectively, a footrest mechanically coupled to said seat member's front end, and a head support mechanically coupled to said back member's upper end, wherein said back member comprises first two or more pairs of massage rollers arranged in two columns symmetrical to said back member's central frame member, each of said first two or more pairs of massage rollers having only one end mounted to said back member's central frame member, wherein said seat member comprises second two or more pairs of massage rollers arranged in two columns symmetrical to said seat member's central frame member, each of said second two or more pairs of massage rollers having only one end mounted to said seat member's central frame member, wherein each of said massage rollers comprises at least one ball bearing, a cylindrical body and a number of evenly spaced bumps embedded in said cylindrical body, and wherein said back member's reclining angle is determined by said gas spring which is controlled by the user through a control handle attached to one of said arms.

8. The massage recliner of claim 7, wherein said footrest comprises a third central frame member and a pair of rotatable foot supports symmetrically coupled to said third central frame member, said pair of foot supports being any of:
a pair of flat pedals;
a pair of cylindrical pads; and
a pair of said massage rollers.

9. The massage recliner of claim 8, wherein said third central frame member is pivotally coupled to said seat member's central frame, and wherein said footrest's position relative to said seat member is adjustable.

10. The massage recliner of claim 8, wherein said third central frame member is coupled to said seat member's central frame by sliding insertion, and wherein said footrest's position relative to said seat member is adjustable.

11. The massage recliner of claim 7, wherein said head support comprises a hard board and a soft pad mounted to said hard board, said hard board being mounted to one or more sliding trails mechanically coupled to said back member's frame, and wherein said head support's position relative to said back member is adjustable.

12. The massage recliner of claim 7, wherein said head support comprises one or more rotatable cylindrical pads coupled in a “U” shaped frame, said “U” shaped frame being coupled to an upper end of said back member's central frame member.

13. The massage recliner of claim 12, wherein said “U” shaped frame is coupled to said back member's central frame member by sliding insertion, and wherein said head support's position relative to said back member is adjustable.

14. A massage recliner that enables a user to exercise, relax and enjoy massage concurrently without using electrical power, comprising: a seat member, a back member, a front leg with two supporting points, two arms attached to said back member, a rear leg with two supporting points, a gas spring which is pivotally attached both to said rear leg and to said back member, a footrest that is pivotally coupled to said seat member's front end and dynamically correlated to said back member's lower end via a connector, and a head support mechanically coupled to said back member, wherein said back member comprises two or more pairs of massage rollers symmetrically coupled to said back member's central frame member and said back member's contour frame, wherein said seat member comprises two or more pairs of massage rollers symmetrically coupled to said seat member's central frame member and its contour frame, wherein each of said massage roller comprises at least one ball bearing, a cylindrical body and a number of evenly spaced bumps embedded in said cylindrical body, and wherein said back member's reclining angle is determined by said gas spring which is controlled by the user through a control handle attached to one of said arms.

15. The massage recliner of claim 14, wherein said footrest comprises a third central frame member and a pair of foot supports symmetrically coupled to said third central frame member, said pair of foot supports being any of:
a pair of rotatable flat pedals;
a pair of rotatable cylindrical pads; and
a pair of said massage rollers.

16. The massage recliner of claim 15, wherein said third central frame member is pivotally coupled to a front end of said seat member's central frame member, and wherein said footrest's position relative to said seat member is adjustable.

17. The massage recliner of claim 15, wherein said third central frame member is coupled to a front end of said seat member's central frame member by sliding insertion, and wherein said footrest's position relative to said seat member is adjustable.

18. The massage recliner of claim 14, wherein said head support comprises a hard board, a soft pad mounted to said hard board, said hard board being mounted to one or more sliding trails mechanically coupled to said back member's frame, and wherein said head support's position relative to said back member is adjustable.

19. The massage recliner of claim 14, wherein said head support comprises one or more rotatable cylindrical pads coupled in a “U” shaped frame, said “U” shaped frame being coupled to an upper end of said back member's central frame member.

20. The massage recliner of claim 19, wherein said “U” shaped frame is coupled to said back member's central frame member by sliding insertion, and wherein said head support's position relative to said back member is adjustable.
